(19) United States
(12) Patent Application Publication
(10) Pub. No.: US 2006/0233544 A1
(43) Pub. Date: Oct. 19, 2006

(54) Bipod platform system for a camera

(76) Inventor: Roman Coppola, Hollywood, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/403,136

(22) Filed: Apr. 11, 2006

Related U.S. Application Data
(60) Provisional application No. 60/670,575, filed on Apr. 11, 2005.

(51) Int. Cl. G03B 17/00

(52) U.S. Cl. 396/428

(57) ABSTRACT

A platform system in which the camera is mounted on a platform is provided. The platform allows for a camera to be mounted thereon and whereby the camera may be raised or lowered along two substantially parallel legs. By providing a system in which the camera is positioned between the legs, the camera can be effectively lowered to the ground (or at least to the height of the base) and can be raised to almost any height without increasing the ground space. Additionally, this configuration allows the camera to raised and lowered during filming much the same as a boom.

This application claims priority to us provisional application Ser. No. 60/670575 filed Apr. 11, 2005.

### FIELD OF THE INVENTION

The invention relates generally to the field of photography. More specifically, the present invention relates to accessories used in photography, including a tripod type system for support of a camera.

### BACKGROUND OF THE INVENTION

Photography is probably one of the most important inventions in history. Photography has transformed how we see the world and what we see of how other people live. Instead of merely hearing or being told what is happening at a location a great distance from us, we can now “see” all sorts of things that are actually many miles and even years away from us. Photography lets us capture moments in time and preserve them for years to come.

The basic technology that makes all of this possible is fairly simple. A device is needed in order to capture the images and display them for later use. A traditional device is a camera. A still film camera is made of three basic elements: an optical element (the lens), a chemical element (the film) and a mechanical element (the camera body itself).

A component of most cameras is the lens. At its simplest, a lens is just a curved piece of glass or plastic. The job of the lens is to take the light that reflects off an object and re-direct that light and image Such that the light comes together to form a real image. That real image is an image that looks like the object for which the camera is aimed.

The lens can perform this function because as light travels from the object to the camera, it changes speed. Light travels more quickly through air than it does through glass or plastic. Therefore most cameras use glass or plastic to slow the travel of light in the camera. When light waves enter a piece of glass at an angle, one part of the wave will reach the glass before another and so will start slowing down first. As the light enters the glass, it bends in one direction. It bends again when it exits the glass because parts of the light wave enter the air and speed up before other parts of the wave. In a standard converging, or convex lens, one or both sides of the glass curves out. This means rays of light passing through will bend toward the center of the lens on entry. In a double convex lens, such as a magnifying glass, the light will bend when it exits as well as when it enters The angle at which light will bend within the structure of the camera is determined by the structure of the lens.

However, because Cameras are capturing light refracted from an object and that the light enters the camera at different times, there is a problem that faces any individual that attempts to take pictures using a camera. If the camera is not kept steady, then the light can pass through the lens at different angles and thereby cause distortions when the light is reduced on film or other medium. This problem of steady positioning of cameras has been a problem for decades and solutions have varied over time.

Most traditional camera supports for still and motion photography utilize some type of support platform to keep the camera and lens at a steady, semi-rigid state. The typical camera support is a tripod platform system. Traditional tripod systems function by supporting a camera on a platform. The platform is mounted to the top of the 3 legs which are then secured to a rigid, non-moving support piece such as a floor. By using the tripod system, an individual may mount the camera on the tripod, whereby the platform is secured to the floor and keeps the lens and camera steady such that pictures are not distorted when taken. There are a number of problems, however, that are inherent in tripod systems.

One of the more glaring problems that tripod systems face is the amount of ground space that the tripod occupies as the height of the camera is raised. More specifically, as the legs of the tripod are extended in order to raise the height of the camera, the distance apart each leg is from one another must be proportionately increased in order to maintain the stability of the camera. Thus, raising the camera very high (e.g. above 6 feet) becomes problematic especially in environments where ground space is limited. Moreover, the space required may be problematic because of other obstructions that may be built into any environment including furniture, walls and the like.

Another problem that is faced by a user of a traditional tripod system in which the camera is positioned on top of the legs, is that the camera can only be lowered as far down as the legs. Therefore, the tripod must be the exact height desired by a user. If the legs collapse to one (1) foot, for example, the camera base cannot be lowered below the 1 foot level. In many cases, the minimum height of the tripod legs exceed 2 feet. This may be problematic when a photographer wishes to capture a long angle picture or a ground level object because the camera is limited to the tripod boundaries.

Traditional tripod systems lack the ease of which one can raise and lower the height of the camera. Moreover, each of the three legs needs to be independently adjusted while supporting the weight of the camera, without insuring any accuracy that the camera is level.

Another problem is that because of the inherent restriction of how low to the ground a camera can be placed considering the leg length, typically a photographer must use a plurality of tripods to achieve different heights and therefore must carry with him/her all the necessary tripods for the purposes intended. Additionally, each time a new tripod is needed for a particular photo shoot, the camera must be removed from the previously used tripod and remounted onto the new tripod.

Thus, there is a need for a new and improved camera platform system that may facilitate a more efficient and effective system for raising and lowering of the camera.

### SUMMARY OF THE INVENTION

platform system has a releasable connection means for connection of the said at least two parallel legs to the base plate.

In an exemplary The present invention is directed toward a platform system in which the camera is mounted on a platform that can be raised or lowered along two substantially parallel legs. By providing a system in which the camera is positioned between the legs, the camera can be effectively lowered to the ground (or at least to the height of the base) and can be raised to almost any height without increasing the ground space. Additionally, this configuration allows the camera to be raised and lowered during filming much the same as a boom.

To this end in an embodiment of the present invention a camera platform system is provided. The camera platform system has a base plate and at least two parallel legs wherein said legs are attached to the base plate. Moreover, the camera platform system also has a tiltable platform releaseably attached to the said at least two parallel legs.

In an exemplary embodiment, the camera platform system has a base plate wherein the base plate is rotatable about the said at least two parallel legs.

In an exemplary embodiment, the camera embodiment, the camera platform system has a tiltable platform wherein said tiltable platform is releaseably attached to the said at least two parallel legs by a connection means.

In an exemplary embodiment, the camera platform system has a tiltable platform wherein said tiltable platform may be releaseably attached to the said at least two parallel legs by a connection means and further wherein said tiltable platform may move upwards or downwards on the at least two parallel legs as needed.

In an exemplary embodiment, the camera platform system has a handle assembly releaseably connected to the top portion of the at least two parallel legs.

In an exemplary embodiment, the camera platform system has a transportation means connected to the base plate of the platform system.

In an exemplary embodiment, the camera platform system has a transportation means connected to the base plate of the platform system wherein said transportation means are wheels that may be removably attached to the base plate of the platform system.

In an exemplary embodiment, the camera platform system has leg extensions which may be added to the existing at least two parallel legs to increase the combined height of the legs of the platform system.

To this end in an embodiment of the present invention a camera platform apparatus is provided. The apparatus has a rotatable base plate and at least a pair of parallel legs wherein said parallel legs are releaseably attached to the rotatable base plate. Moreover, the apparatus has a tiltable platform for placement of a camera thereon wherein said tiltable platform is releaseably attached to the said at least a pair of parallel legs.

In an exemplary embodiment, the camera platform apparatus has a connection means for releaseably connecting the at least a pair of parallel legs to the base plate.

In an exemplary embodiment, the camera platform apparatus has a handle assembly that is coupled to the at least a pair of parallel legs for transport of the camera platform apparatus.

In an exemplary embodiment, the camera platform apparatus has leg extensions which may be added to the existing at least two parallel legs to increase the combined height of the legs of the platform apparatus.

In an exemplary embodiment, the camera platform apparatus has a transportation means connected to the base plate of the platform system wherein said transportation means are wheels that may be removably attached to the base plate of the platform apparatus.

To this end, in an exemplary embodiment of the present invention, a method for using a camera platform system, said method comprising the steps of: providing a rotatable base plate; providing at least a pair of parallel legs wherein said parallel legs are releaseably attached to the rotatable base plate; and configuring a tiltable platform for placement of a camera thereon wherein said tiltable platform is releaseably attached to the said at least a pair of parallel legs.

In an exemplary embodiment, the method further comprises the step of: attaching a camera to the tiltable platform.

In an exemplary embodiment, the method further comprises the step of: allowing for movement of a camera and tiltable platform up and down the said at least pair of parallel legs on the platform system.

In an exemplary embodiment, the method further comprises the step of: adding a handle assembly to the parallel legs for transporting the platform assembly

In an exemplary embodiment, the method further comprises the step of: removeably adding a transportation means for connecting to the base plate of the platform system wherein said transportation means are wheels.

In an exemplary embodiment, the method further comprises the step of: allowing for removal and disassembly of the camera, parallel legs and the tiltable platform to pack and transport the system from one location to another.

To this end, in an exemplary embodiment of the present invention, a platform system is provided. The platform system is equipped to support a camera mounted thereon.

In another exemplary embodiment, a platform system is provided wherein the platform system may be used in still photography.

Yet another exemplary embodiment of the present invention is to provide a platform system wherein the platform system may be utilized in motion picture photography.

Still another exemplary embodiment of the present invention is to provide a unique platform system wherein the platform system has two posts.

Another exemplary embodiment of the present invention is to provide a unique platform system wherein the platform system has two parallel posts mounted to a base plate.

Yet another exemplary embodiment of the present invention is to provide a unique platform system wherein the platform system has two parallel posts mounted to a base place wherein the base plate is of sufficient weight to keep the center of gravity low.

Another exemplary embodiment of the present invention is to provide a unique platform system wherein the platform system may have a tiltable plate.

Still another exemplary embodiment of the present invention is to provide a unique platform system wherein the platform system may have a tiltable plate wherein the tiltable plate is releaseably secured to the two parallel posts.

A further exemplary embodiment of the present invention is to provide a unique platform system wherein the platform system may provide for mounting a camera thereon for steady, efficient photographic capabilities.

Another exemplary embodiment of the present invention is to provide a unique platform system wherein the platform system may provide for mounting a camera on the tiltable plate wherein the tiltable plate may be connected to the two parallel posts.

Yet another exemplary embodiment of the present invention is to provide a unique platform system wherein a camera may be releaseably mounted to a tiltable plate connected to the platform system.

Still another exemplary embodiment of the present invention is to provide a unique platform system wherein the two parallel posts may terminate at its top portion in a parallel fashion to each other.

A further exemplary embodiment of the present invention is to provide a unique platform system wherein the two parallel posts may be connected at their upper most portions in the form of a “U” shaped apparatus.

Yet another exemplary embodiment of the present invention is to provide a unique platform system wherein the two parallel posts may be connected at their upper most portions in the form of a “U” shaped apparatus and further wherein the “U” shaped portion of the two parallel posts may be utilized to transport the platform from one location to another location.

Another exemplary embodiment of the present invention is to provide a unique platform system wherein the platform system may have wheels to transport the platform from one location to another location.

Still another exemplary embodiment of the present invention is to provide a unique platform system wherein the platform system may have removable transportation means such as wheels to transport the platform and wherein the transport means may be detached and removed when the platform is in use during photography.

Yet another exemplary embodiment of the present invention is to provide a unique platform system that may allow for the camera to be adjusted on the two parallel posts.

Another exemplary embodiment of the present invention is to provide a unique platform system wherein the platform system may allow for the camera to be positioned at a location in close proximity to the ground.

Still another exemplary embodiment of the present invention is to provide a unique platform system wherein the platform system may allow for the camera to be raised as high as one would like and only limited to the height of the two parallel posts.

A further exemplary embodiment of the present invention is to provide a unique platform system wherein the platform system may have extensions that may be added to the two parallel posts to allow for further heightening of the system and allow for the camera to be positioned at a higher position that if the extensions were not present.

Another exemplary embodiment of the present invention is to provide a unique platform system wherein the platform system allows for panning and tilting of the camera about the platform.

Yet another exemplary embodiment of the present invention is to provide a unique platform system wherein a camera mounted to the platform may be more easily raised and lowered than a traditional tri-pod system

Still another exemplary embodiment of the present invention is to provide a unique platform system that may be lightweight.

Another exemplary embodiment of the present invention is to provide a unique platform system that may be constructed of a lightweight alloy which may improve transport of the platform system from one location to another.

A further exemplary embodiment of the present invention is to provide a unique platform system that may be manufactured in a cost effective manner.

Yet another exemplary embodiment of the present invention is to provide a unique platform system wherein the platform and the two parallel posts may be flexible such that they may be tilted to capture a particular camera angle and whereby the camera may be rotated about the two parallel posts.

Still another exemplary embodiment of the present invention is to provide a unique platform system wherein the platform may have fewer moving parts than traditional tripods such that there are less parts to break.

Another exemplary embodiment of the present invention is to provide a unique platform system having a tiltable plate whereby a camera is removably attached to said tiltable plate and further wherein the tiltable plate is connected to the platform via the two parallel posts.

Yet another exemplary embodiment of the present invention is to provide a unique platform system having a tiltable plate wherein the plate is connected to the parallel posts by a connection means and further wherein the plate is removable from the parallel posts.

Another exemplary embodiment of the present invention is to provide a unique platform system wherein the system may have a tiltable plate connected to the two parallel posts wherein the tiltable plate is connected to said posts by a connection means and wherein the tiltable plate may be removed from the parallel posts such that the camera may be pre-mounted on the tiltable plate prior to the tiltable plate being connected to the two parallel posts.

Still a further exemplary embodiment of the present invention is to provide a unique platform system wherein the system may have a tiltable plate connected to the two parallel posts wherein the tiltable plate is connected to said posts by a connection means and wherein the tiltable plate may be connected to a singular post or two both posts yet still perform the function of accommodating the camera thereon.

Yet another exemplary embodiment of the present invention is to provide a unique platform system wherein the system may have two posts wherein the posts diverge from one another in an upward fashion wherein the tiltable plate may expand and contract in response to the rising divergent posts.

Yet a further exemplary embodiment of the present invention, the platform system may have a base plate and top plate wherein the base plate may be in close proximity to the ground and the top plate may be located at the top portion of the two parallel posts.

Still a further exemplary embodiment of the present invention is to provide a platform system that may have a top plate and a base plate wherein the top plate and base plate are connected to one another by the two parallel posts and wherein both the top plate and the base plate are removably attachable to the two parallel posts.

In a further exemplary embodiment of the present invention, the platform system includes a universal panning base into which both legs are mounted. The base is adapted to be rotatable thus allowing the camera to be easily panned.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWING

FIG. 1 is an perspective view of a platform system according to the present invention;

FIG. 2 is a side perspective view of the platform system showing an exemplary embodiment of the present invention;

FIG. 3 is another side perspective view of the platform system showing an exemplary embodiment of the present invention;

FIG. 4 is another side perspective view of the platform system showing an exemplary embodiment of the present invention;

FIG. 5 is a side perspective view of the platform system showing an exemplary embodiment of the present invention;

FIG. 6 is a side perspective view of the platform system illustrating additional extensions of the platform in an exemplary embodiment of the present invention;

FIG. 7 is a side perspective view of the platform system illustrating the extension added to the platform in an exemplary embodiment of the present invention;

FIG. 8 is a side perspective view of the platform system illustrating the movement of the camera and tiltable plate on the platform system in an exemplary embodiment of the present invention;

FIG. 9 is a side perspective view of the platform system illustrating the handle assembly and the platform system in an exemplary embodiment of the present invention;

FIG. 10 is a side perspective view of the platform system illustrating the handle assembly and the platform system in combination in an exemplary embodiment of the present invention;

FIG. 11 is a side perspective view of the platform system illustrating the handle assembly and transportation means in an exemplary embodiment of the present invention;

FIG. 12 is a back perspective view of the platform system illustrating the handle assembly and transportation means in an exemplary embodiment of the present invention; and

FIG. 13 is a front view of a platform system illustrating a different exemplary embodiment of the present invention.

### DETAILED DESCRIPTION

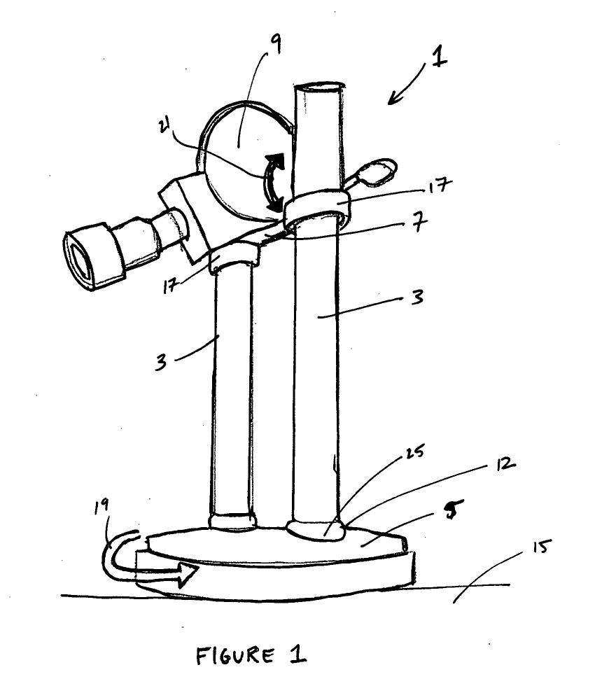

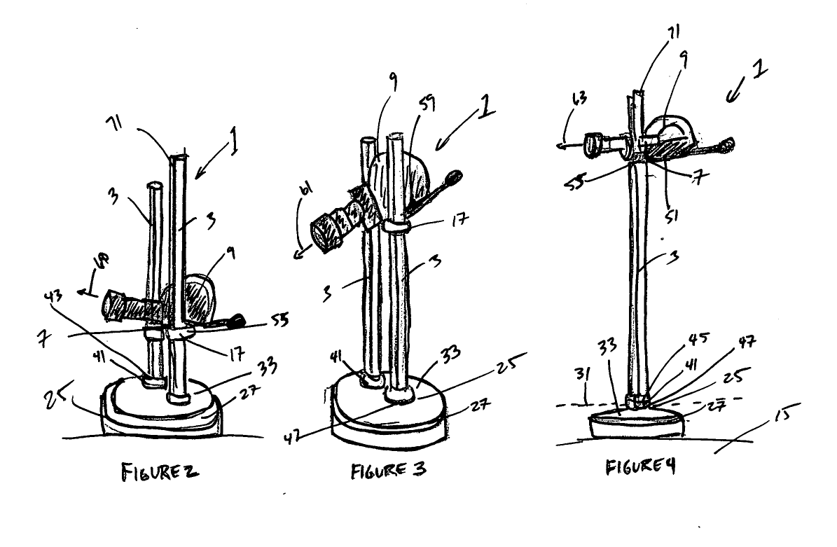

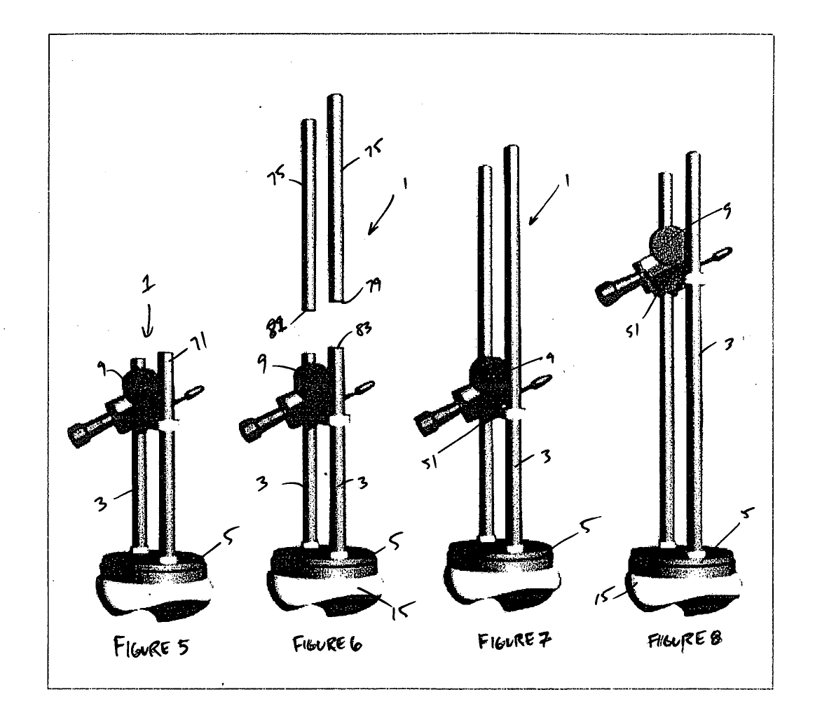

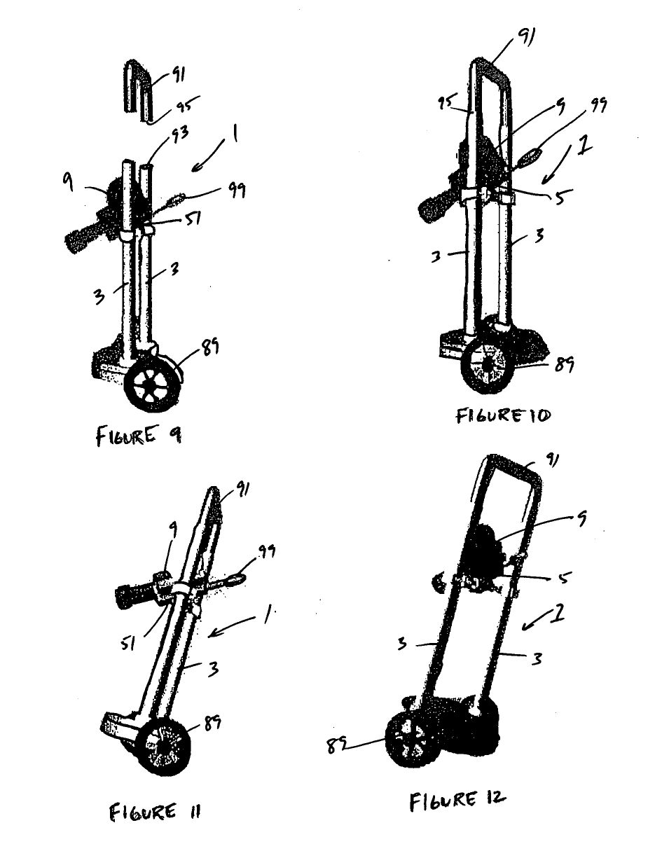

Turning now to the drawings wherein elements are identified by numbers and like elements are identified by like numbers throughout the 13 figures, the invention is depicted in FIG. 1 and shows a new platform system 1 to be used in photography.

Referring first to FIG. 1, a platform system 1 is provided. The platform system 1 may include in an exemplary embodiment, two substantially parallel legs 3, a universal rotatable base 5, and a platform 7 to support the camera 9.

It should be appreciated that while preferred embodiments utilize two substantially parallel legs, the camera could be mounted to more or less than two legs so long as it is sufficiently supported. The substantially parallel legs 3 can be configured so as to be extendible and collapsible, and in that respect, they can be telescoping or extendible by addition of extra lengths which is further illustrated in FIG. 6. In any case, regardless of how high the substantially parallel legs 3 extend, the camera 9 can be lowered to a height 12 substantially equivalent to the height of the base 5 above the ground 15.

As further illustrated in FIG. 1, the platform 7 may be disposed between the substantially parallel legs 3 and may be coupled to brackets 17. The brackets 17 cooperate with the substantially parallel legs 3 to facilitate upward and downward movement as indicated by arrow 19. Such movement as indicated by arrow 19 may further be facilitated by use of a cranking mechanism (not shown) or some other type of manual or automatic adjustment that causes the platform 7 to move up and down along the length of the substantially parallel legs 3.

Significantly, the camera 9 may be raised or lowered without any disruption to the filming 10 process (i.e. while rolling film) and/or interruption of the capture of pictures (not shown).

The platform 7 may also be adapted to be tiltable as shown by arrow 21 and this function may also be utilized while filming. It will be understood by one of skill in the art that the tilting function can be accomplished in various ways including by providing a platform 7 that may pivot upward and downward and/or in any direction necessary to capture the desired photograph or camera angle.

Referring to FIGS. 1-4, the platform system 1 may have a base 5 that may be in close proximity with the ground 15. The base 5 will typically be supported by the ground 15 and may be a size and sufficient weight to keep the whole platform system 1 supported. Additionally, the base 5 may have a parallel leg 3 support structure 25 and a circular disc shaped rotation portion 27 that may be configured to be rotatable. Though the shape and size of the base 5 may vary considerably, a notable aspect of the base 5 is its height off of the ground 15 as indicated by dotted line 31. The height 31 of the base 5 is important because it may dictate how low the camera 9 can be lowered about the platform system 1. The camera 9 may not be lowered beyond the top portion 33 of the base 5. Therefore, the camera 9 height on the platform system 1 is limited by the height 31 of the top portion 33 of the base 5. Therefore, in an exemplary embodiment of the present invention, it is advantageous for the height of the base 5 to be preferably minimized to the greatest extent possible. In especially preferred embodiments, the base 5 may be no more that ten (10) centimeters from the ground 15. In even more preferred embodiments, the base 5 is no more than five (5) centimeters from the ground 15.

In addition to having a relatively low profile, the base 5, in a preferred embodiment of the present invention would be rotatable as indicated by arrow 19. Of course, rotation of the base 5 can be accomplished using manual operations and/or automated operations and like the panning and raising/lowering operations, it can be performed during filming. Thus, a camera 9 mounted to a platform system 1 according to the inventive concepts disclosed herein can be panned, tilted, and raised or lowered all during the process of filming.

Looking now at FIGS. 2-4 of the present invention, it can be seen that the two parallel legs 3 may be attached with a leg connection means 41 to the base 5 of the platform system 1. In an embodiment, the leg connection means 41 may be a threading system wherein the legs 3 have a threaded portion at their bottom portion 45 and whereby the legs 3 are threaded into a corresponding receiving portion 47 of the base 5 to facilitate connection between the base 5 and the legs 3. Additionally, as illustrated in FIGS. 2-4, a camera 9 may be mounted on a tiltable platform 51 that may be contained between the two parallel legs 3. The tiltable platform 51 may be attached to the two parallel legs 3 by a platform connection means 55. The platform connection means 55 may be any device to attach the tiltable platform 51 to the parallel legs 3. In an embodiment the connection means 55 may be clamp whereby the clamp is releaseably engaged and disengaged from the parallel legs 3. When desired the tiltable platform 51 may be removed from the platform system 1. This may be advantageous when a user desires to mount a new or different camera 9 than the one that had previously been mounted on the platform system 1. A user may disengage the tiltable platform 51 from the platform system 1 for mounting of the camera 9 thereon. Additionally, the tiltable platform 51 may have linkage (not shown). The linkage (not shown) may be located on the top portion 59 of the tiltable platform 51. The linkage (not shown) may serve to provide a detachable connection between the tiltable platform 51 and the camera 9. The linkage may be a strap, threaded mechanism, clamp, or any other device that may allow for the proper union between the tiltable platform 51 and the camera 9.

As shown in FIGS. 2-4, the tiltable platform 51 may be positioned on a plurality of locations on the platform system 1. Additionally, the tiltable platform 51 may be positioned such that the camera 9 attached thereto may be positioned to face an upward direction 60 as illustrated in FIG. 2, a downward direction 61 as illustrated in FIG. 3, or a neutral position 63 as illustrated in FIG. 4. Moreover, as further illustrated, the tiltable platform 51 may be positioned anywhere on the parallel legs 3, extending from the base 5 of the platform system to the top portion 71 of the parallel legs 3.

FIGS. 5-8 further illustrate the parallel legs 3 in conjunction with the base 5 of the platform system 1. Further illustrated in FIG. 6 are the extension legs 75 which may be added to the top portion 71 of the parallel legs 3. The bottom portion 79 of the extension legs 75 may have a connection means 81 thereon. In an exemplary embodiment, the connection means 81 may be a threaded mechanism whereby the bottom portion 79 of the extension legs 75 may be threaded into a corresponding threaded portion 83 of the parallel legs 3. This addition of the extension legs 75 may allow for increased height capacity of the platform system 1 and the camera 9 attached thereto. As illustrated in FIGS. 7 and 8, in an exemplary embodiment, the extension legs 75 are provided with smooth transition between the parallel legs 3 such that the camera 9 and tiltable platform 51 may be moved up on to the extension legs 75 when desired by a user in a seamless and uninterrupted fashion and without the need to re-adjust the tiltable platform 51 or the camera 9.

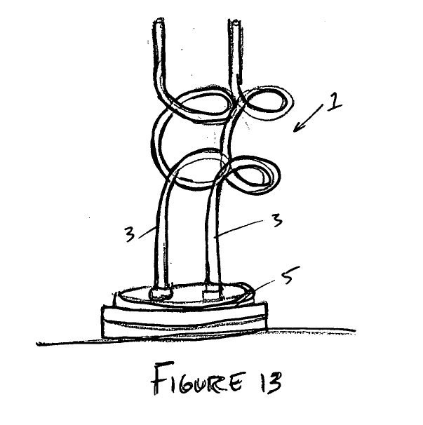

FIGS. 9-12 illustrate the transport of the platform system 1 in an exemplary embodiment. In a preferred embodiment, the platform system 1 may have a transport mechanism 89 to move the system 1 from one location to another. In an exemplary embodiment, the transport mechanism 89 may be wheels as illustrated in the figures. However it is contemplated that any mechanism may be used to transport the platform system 1 from one location to another. The wheels 89 may be adapted for fitment on the base 5 of the platform system such that the wheels 89 may be easily removed once the platform system 1 is in the proper location for use. Additionally as illustrated in FIG. 9, a handle 91 may be adapted for fitment about the top portion 93 of the parallel legs 3. The handle 91 may be used to transport the platform system 1 and may facilitate easier movement thereof. The handle 91 in an exemplary embodiment may be attached to the top portion 93 of the parallel legs 3 by a similar connection means 95 as the extension legs 75. However, it is further contemplated that any connection means 95 may be used, including snap fitment, a screw, threaded mechanism, or any other connection mechanism for attachment of the handle to the top portion 93 of the parallel legs 3. As illustrated in FIGS. 10-12, once the handle 91 is attached, the platform system 1 may be more easily transported from one location to another. As is further illustrated by the FIGS. 10-12, the tiltable platform 51 may be adjusted during transportation of the platform system 1. The tiltable platform 51 may be adjusted and moved into a position parallel with the parallel legs 3 of the system 1 as to provide for easier facilitation of movement relating to the platform system 1.

FIGS. 9-12 also illustrate the tiltable platform 51 having a movement arm 99 wherein the movement arm may be connected to the tiltable platform 51. In an alternative embodiment, the movement arm 99 may be connected to the camera 9 mounted on the tiltable platform. The movement arm 99 may allow for manual adjustment of the camera 9 such that panning and tilting may be manipulated by a user without the necessity to touch the camera 9.

In another exemplary embodiment, as illustrated in FIG. 13, the parallel legs 3 of the platform system 1 may be constructed in a helical nature to allow for panning, tilting and adjustment of height all by simply moving the tiltable platform 51. It should be understood that the legs 3 of the platform system 1 may be configured in any way to allow for the tiltable platform 51 to be attached thereto and for tilting and panning of the camera in relation to the ground 15.

Thus, specific embodiments and applications of a bipod platform system have been disclosed. It should be apparent, however, to those skilled in the art that many more modifications besides those already described are possible without departing from the inventive concepts herein. The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A camera platform system comprising:
a base plate;
at least two parallel legs wherein said legs are attached to the base plate; and
a tiltable platform releaseably attached to the said at least two parallel legs.

2. The camera platform system of claim 1, wherein said base plate is rotatable about the said at least two parallel legs.

3. The camera platform system of claim 1, further comprising:
a releasable connection means for connection of the said at least two parallel legs to the base plate.

4. The camera platform system of claim 1 wherein said tiltable platform is releaseably attached to the said at least two parallel legs by a connection means.

5. The camera platform system of claim 1, wherein said tiltable platform may be releaseably attached to the said at least two parallel legs by a connection means and further wherein said tiltable platform may move upwards or downwards on the at least two parallel legs as needed.

6. The camera platform system of claim 1 further comprising:
a handle assembly releaseably connected to the top portion of the at least two parallel legs.

7. The camera platform system of claim 1, further comprising:
a transportation means connected to the base plate of the platform system.

8. The camera platform system of claim 1 further comprising:
a transportation means connected to the base plate of the platform system wherein said transportation means are wheels that may be removably attached to the base plate of the platform system.

9. The camera platform system of claim 1 further comprising:
leg extensions which may be added to the existing at least two parallel legs to increase the combined height of the legs of the platform system.

10. A camera platform apparatus comprising:
a rotatable base plate;
at least a pair of parallel legs wherein said parallel legs are releaseably attached to the rotatable base plate; and
a tiltable platform for placement of a camera thereon wherein said tiltable platform is releaseably attached to the said at least a pair of parallel legs.

11. The camera platform apparatus described in claim 10 further comprising:
a connection means for releaseably connecting the at least a pair of parallel legs to the base plate.

12. The camera platform apparatus describe in claim 10 further comprising:
a handle assembly that is coupled to the at least a pair of parallel legs for transport of the camera platform apparatus.

13. The camera platform apparatus described in claim 10 further comprising:
leg extensions which may be added to the existing at least two parallel legs to increase the combined height of the legs of the platform apparatus.

14. The camera platform apparatus described in claim 10 further comprising:
a transportation means connected to the base plate of the platform system wherein said transportation means are wheels that may be removably attached to the base plate of the platform apparatus.

15. A method for using a camera platform system, said method comprising the steps of:
providing a rotatable base plate;
providing at least a pair of parallel legs wherein said parallel legs are releaseably attached to the rotatable base plate; and
configuring a tiltable platform for placement of a camera thereon wherein said tiltable platform is releaseably attached to the said at least a pair of parallel legs.

16. The method of claim 15, further comprising the step of:
attaching a camera to the tiltable platform.

17. The method of claim 15, further comprising the step of:
allowing for movement of a camera and tiltable platform up and down the said at least pair of parallel legs on the platform system.

18. The method of claim 15, further comprising the step of:
adding a handle assembly to the parallel legs for transporting the platform assembly.

19. The method of claim 15, further comprising the step of:
removeably adding a transportation means for connecting to the base plate of the platform system wherein said transportation means are wheels.

20. The method of claim 15, further comprising the step of:
allowing for removal and disassembly of the camera, parallel legs and the tiltable platform to pack and transport the system from one location to another.
